(19) United States
(12) Patent Application Publication
(10) Pub. No.: US 2025/0174753 A1
(43) Pub. Date: May 29, 2025

(54) SECONDARY BATTERY

(71) Applicant: Samsung SDI Co., Ltd., Yongin-si (KR)

(72) Inventor: Yun Seok CHOI, Yongin-si (KR)

(21) Appl. No.: 18/607,282

(22) Filed: Mar. 15, 2024

(30) Foreign Application Priority Data
Nov. 23, 2023 (KR) 10-2023-0163982

(51) Int. Cl. H01M 10/654; H01M 10/0585; H01M 10/613; H01M 10/6554; H01M 10/6572; H01M 50/188

(52) U.S. Cl. CPC H01M 10/654; H01M 10/0585; H01M 10/613; H01M 10/6554; H01M 10/6572; H01M 50/188

(57) ABSTRACT

Provided is a secondary battery including an electrode assembly including a first electrode plate, a separator, and a second electrode plate, a case accommodating the electrode assembly, a cap plate sealing the case, a first terminal electrically connected to the first electrode plate, and exposed to outside the cap plate, a cooling member inside the case, and contacting the electrode assembly, and a cooling terminal coupled to the cooling member, and exposed to outside of the cap plate.

### CROSS-REFERENCE TO RELATED APPLICATION

The present application claims priority to and the benefit of Korean Patent Application No. 10-2023-0163982, filed on Nov. 23, 2023, in the Korean Intellectual Property Office, the entire disclosure of which is incorporated herein by reference.

### BACKGROUND

### 1. Field

Embodiments relate to a secondary battery.

### 2. Description of the Related Art

A secondary battery is a chargeable and dischargeable battery, unlike a primary battery, which is not chargeable. Low-capacity secondary batteries, in which a single battery cell is packaged in a pack, are used in small and portable electronic devices, such as mobile phones and camcorders. In addition, large-capacity secondary battery modules provided in battery pack units, in which dozens of battery packs are connected, are being widely used as power sources for driving motors in hybrid vehicles, electric vehicles, etc.

A secondary battery may be manufactured by embedding a stacked or wound electrode assembly and an electrolyte in a case with a separator between positive and negative electrode plates, and by then installing a cap plate on the case. The electrode assembly may have a non-coating portion tab protruding toward a side or upper portion, and a current collection structure may be connected to the non-coating portion tab.

In such a secondary battery, a plurality of secondary batteries are connected to each other in series in the form of a battery module or battery pack, and then may be mounted on a vehicle or an energy storage device. As the battery module or battery pack increases in energy density, heat generation increases, and various methods for reducing the heat generation or improving heat dissipation for user safety may be suitable.

The above-described information serves as the background of the present disclosure, and is only for improving understanding of the background of the present disclosure, and thus may include information that does not constitute the related art.

### SUMMARY

Aspects of some embodiments of the present disclosure provide a secondary battery capable of improving cooling performance.

According to some embodiments, a secondary battery includes an electrode assembly including a first electrode plate, a separator, and a second electrode plate, a case accommodating the electrode assembly, a cap plate sealing the case, a first terminal electrically connected to the first electrode plate, and exposed to outside the cap plate, a cooling member inside the case, and contacting the electrode assembly, and a cooling terminal coupled to the cooling member, and exposed to outside of the cap plate.

The cooling member ma have a flat plate shape.

The cooling member may include an inner cooling member between the first electrode plate and the separator, or between the second electrode plate and the separator, inside the electrode assembly.

The cooling member may further include an outer cooling member that contacts an outer surface of the electrode assembly.

The outer cooling member may include two outer cooling members respectively contacting and covering long sides of the electrode assembly.

The inner cooling member may be between the electrode assemblies at regular intervals.

The cooling member may be coupled to the cooling terminal through a conducting wire.

The cooling member and the conducting wire may be coated with an insulating material.

The insulating material may cover the cooling member and the conducting wire.

The insulating material may include silica aerogel or polyimide foam.

The cooling member may include a thermoelectric element or thermoelectric material.

The cooling member may have a size that is less than that of the first electrode plate or the second electrode plate.

The electrode assembly may include a stack-type electrode assembly in which the first electrode plate, the separator, the second electrode plate, and the separator are sequentially stacked.

The secondary battery may further include a sealing member between the cooling terminal and the cap plate.

The cooling member may include an outer cooling member contacting an outer surface of the electrode assembly.

### BRIEF DESCRIPTION OF THE DRAWINGS

The accompanying drawings are included to provide a further understanding of the present disclosure, and are incorporated in, and may include a part of, this specification. The drawings illustrate embodiments of the present disclosure and, together with the description, serve to explain aspects of the present disclosure. In the drawings:

FIG. 1 illustrates a perspective view of a secondary battery according to embodiments;

FIG. 2 illustrates a cross-sectional view taken along the line 2-2′ of FIG. 1;

FIG. 3 illustrates a perspective view of an electrode coupled to a cooling member in the secondary battery of FIG. 1;

FIG. 4 illustrates an exploded perspective view of a state in which the cooling member and the electrode assembly of FIG. 3 are disassembled; and

FIG. 5 illustrates a transmissive perspective view of connection between the cooling member and the cooling terminal in the secondary battery of FIG. 1.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure. The present disclosure covers all modifications, equivalents, and replacements within the idea and technical scope of the present disclosure. Further, each of the features of the various embodiments of the present disclosure may be combined with each other, in part or in whole, and technically various interlocking and driving are possible. Each embodiment may be implemented independently of each other or may be implemented together in an association.

In the drawings, the relative sizes of elements, layers, and regions may be exaggerated for clarity and/or descriptive purposes. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

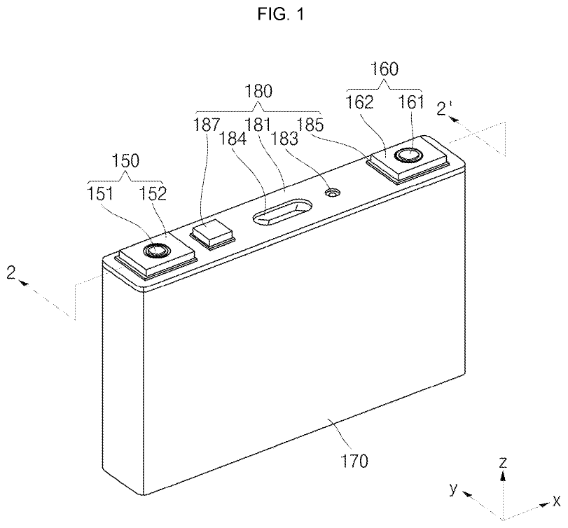

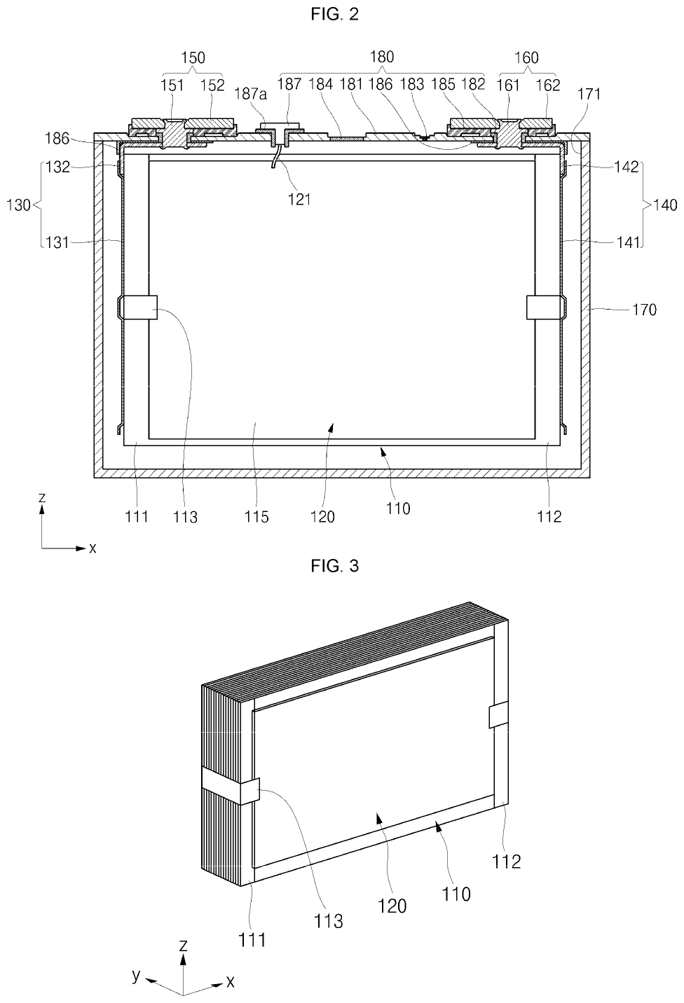

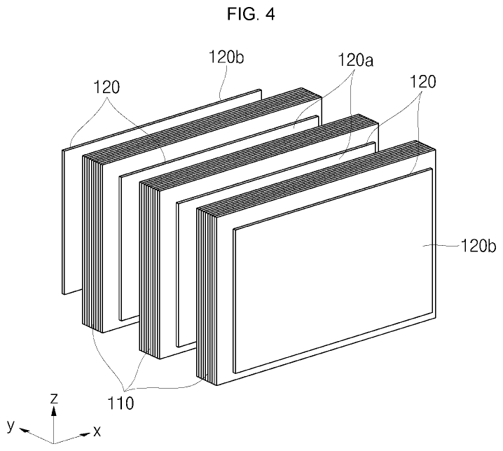

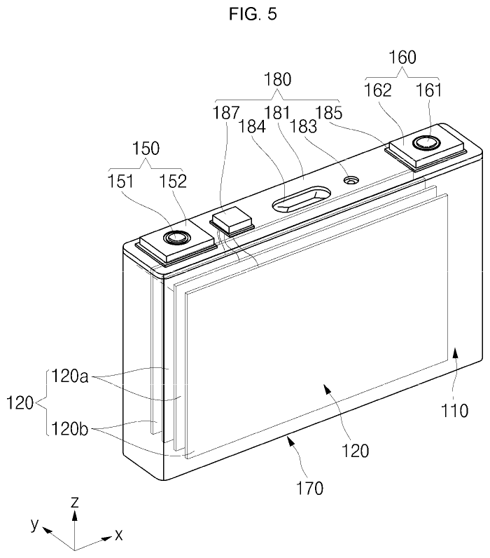

FIG. 1 illustrates a perspective view of a secondary battery according to embodiments. FIG. 2 illustrates a cross-sectional view taken along the line 2-2′ of FIG. 1. FIG. 3 illustrates a perspective view of an electrode coupled to a cooling member in the secondary battery of FIG. 1. FIG. 4 illustrates an exploded perspective view of a state in which the cooling member and the electrode assembly of FIG. 3 are disassembled. FIG. 5 illustrates a transmissive perspective view of connection between the cooling member and the cooling terminal in the secondary battery of FIG. 1. Hereinafter, a secondary battery according to embodiments will be described with reference to FIGS. 1 to 5.

As illustrated in FIGS. 1 to 5, a secondary battery 100 may include an electrode assembly 110, a cooling member 120, a first current collector plate 130, a second current collector plate 140, a first terminal 150, a second terminal 160, a case 170, and a cap assembly 180. In some embodiments, the first terminal 150 may include a first terminal pillar 151 and a first terminal plate 152, and the second terminal 160 may include a second terminal pillar 161 and a second terminal plate 162.

The electrode assembly 110 may be provided by stacking a plurality of stacks of a first electrode plate, a separator, and a second electrode plate, each of which is provided in a thin plate or film shape. In some embodiments, the first electrode plate may operate with a first polarity, for example, may operate as a positive electrode, and the second electrode plate may operate with a second polarity, for example, may operate as a negative electrode. In some embodiments, the first electrode plate and the second electrode plate may have different respective polarities depending on selection of a person skilled in the art.

The first electrode plate is formed by applying a first electrode active material, such as a transition metal oxide, on a first electrode collector formed of metal foil, such as aluminum foil, and may include a first electrode non-coating portion 111 on which the first electrode active metal is not applied. The first electrode non-coating portion 111 may provide a path for a current flow between the first electrode plate and the outside.

In some embodiments, the first electrode non-coating portion 111 may overlap at the same position if the first electrode plate is stacked, thereby providing a multi-tap structure. The first electrode non-coating portion 111 may protrude to one side of the electrode assembly 110. In some embodiments, a plurality of first electrode non-coating portions 111 may be welded to each other to provide one first current collector tab. The first electrode non-coating portion 111 may be aligned to one side of the electrode assembly 110 to protrude.

The second electrode plate is formed by applying a second electrode active material, such as graphite or carbon, on a first electrode collector formed of metal foil, such as nickel or copper foil, and includes a second electrode non-coating portion 112 on which the second electrode active metal is not applied.

In some embodiments, the second electrode non-coating portion 112 may also overlap at the same position if the second electrode plate is stacked, thereby providing a multi-tap structure. The second electrode non-coating portion 112 may protrude to the other side of the electrode assembly 110. In some embodiments, a plurality of second electrode non-coating portions 112 may be welded to each other to provide one second current collector tab.

The separator may be located between the first electrode plate and the second electrode plate to reduce or prevent the likelihood of a short circuit, and to enable movement of lithium ions. The separator may be made of polyethylene, polypropylene, or a composite film of polyethylene and polypropylene. The material of the separator does not limit the scope of the present disclosure.

In some embodiments, the electrode assembly 110 may be maintained in a stacked state through a separate insulating tape 113 attached to a partial area(s) of an outer surface thereof after stacking a plurality of electrode plates (the first electrode plate and the second electrode plate) together with the cooling member 120. In some embodiments, the insulating tape 113 may maintain the shape of the cooling member 120 stacked together with the electrode assembly 110. Thereafter, the insulating tape 113 may allow the first and second electrode non-coating portions 111 and 112 of the electrode assembly 110 to be respectively welded to the current collector plates 130 and 140 at accurate positions, and may be fixed so that a structure of the electrode assembly 110 coupled to the cooling member 120 is maintained within the final secondary battery structure.

In some embodiments, the electrode assembly 110 and the cooling member 120 may be accommodated in the case 170 together with an electrolyte. The electrolyte may include an organic solvent, such as ethylene carbonate (EC), propylene carbonate (PC), diethyl carbonate (DEC), ethyl methyl carbonate (EMC), or dimethyl carbonate (DMC), and a lithium salt, such as LiPF₆ or LiBF₄. The electrolyte may be liquid, solid, or gel.

The cooling member 120 may have a substantially flat plate shape, and may include an inner cooling member 120a, which is interposed between the plurality of electrode plates of the electrode assembly 110 and the separator, and two outer cooling members 120b, each of which contacts a long side of the electrode assembly 110. Each of the two outer cooling members 120b may be interposed between the electrode assembly 110 and the case 170. In some embodiments, the inner cooling member 120a may be located inside the electrode assembly 110. The inner cooling member 120a may be interposed between the electrode plate and the separator in the electrode assembly 110. For example, as illustrated in FIGS. 4 and 5, the cooling member 120 may include two outer cooling members 120b and two inner cooling members 120a, but in the present disclosure, the number of cooling members 120 may not be limited thereto. The inner cooling member 120a may be located between the electrode assemblies 110 at regular intervals. In some embodiments, the number of electrode assemblies 110 interposed between the two cooling members 120 may be the same, and their thicknesses may be the same. For example, the cooling member 120 may be inserted one by one for every 10 to 30 electrode plates stacked in the electrode assembly 110. In some embodiments, if twenty electrode plates are interposed between the two cooling members 120, the cooling member 120 may include ten first electrode plates and ten second electrode plates, which are sequentially stacked. In some embodiments, the separator may be further interposed between the first and second electrode plates. As the number of electrode plates interposed between the two cooling members 120 decreases, cooling performance may be improved. If the number of cooling members 120 increases, capacity of the electrode assembly 110 for the same volume may decrease.

In some embodiments, the cooling member 120 may include at least one of the inner cooling member 120a or the outer cooling member 120b. The cooling member 120 may include only the inner cooling member 120a located inside the electrode assembly 110, or may include only the outer cooling member 120b located outside the electrode assembly 110. In some embodiments, if the cooling member 120 includes both the inner cooling member 120a and the outer cooling member 120b, the cooling performance may be improved.

The cooling member 120 may be electrically connected to the cooling terminal 187 exposed to the outside of the cap plate 181 through a conducting wire 121. In some embodiments, the conducting wire 21 may be accommodated in the case 170. The conducting wire 121 may electrically connect each cooling member 120 to each cooling terminal 187. The number of conducting wires 121 may be the same as the number of cooling members 120. Each of the plurality of cooling members 120 may be electrically connected to the cooling terminal 187 through the conducting wire 121.

The cooling member 120 may be made of a material having high thermal conductivity that does not react with the electrolyte or the electrode plates of the electrode assembly 110. For example, the cooling member 120 may include a thermoelectric element or thermoelectric material. This cooling member 120 may be electrically connected to the cooling terminal 187 exposed on an upper side of the cap plate 181. If current is applied through the cooling terminal 187, the cooling member 120 may cool the electrode assembly 110.

In some embodiments, the cooling member 120 may be coated with an insulating material. In some embodiments, the conducting wire 121 that electrically connects the cooling member 120 to the cooling terminal 187 may also be coated with an insulating material. The insulating material may be a material that has electrical and thermal insulation properties. For example, the insulating material may be silica aerogel or polyimide foam. In some embodiments, the insulating material may reduce or prevent the likelihood of the cooling member 120 and the conducting wire 121, which are located inside the case 170, contacting and reacting with the first electrode plate, the second electrode plate, or the electrolyte of the electrode assembly 110. The insulating material may also cover an area on which the conducting wire 121 and the cooling member 120 contact, and are coupled to, each other. In some embodiments, the cooling member 120, the conducting wire 121, and the insulating material may be integrated with each other. The conducting wire 121 may not be coated with an insulating material at only a portion of the area that contacts the cooling terminal 187. In one or more embodiments, after the conducting wire 121 is coupled to the cooling terminal 187 by welding, the conducting wire 121 may be covered with the insulating tape and/or the insulating material.

The cooling member 120 may have a size that is less than that of the first or second electrode plate. A length of the cooling member 120 in a first direction x, which is a longitudinal direction of the cap plate 181, may be less than a length of each of the first and second electrode plates. In some embodiments, the length of the cooling member 120 in a second direction y, which is a width direction of the cap plate 181, may be less than that of each of the first and second electrode plates. For example, the cooling member 120 may not overlap the first electrode non-coating portion 111 and the second electrode non-coating portion 112 of the electrode assembly 110. In one or more embodiments, the cooling member 120 may not be interposed between the stacked first electrode non-coating portions 111 and between the stacked second electrode non-coating portions 112.

In some embodiments, the size of the cooling member 120 may be a size of a surface provided by the first direction x, which is a surface corresponding to the long side of the electrode assembly 110, and a third direction z, which is a height direction of the case 170. As described above, the cooling member 120 may improve safety by individually cooling the secondary batteries 100 through the cooling member 120, even if the plurality of secondary batteries 100 are electrically connected to each other in the form of a module or pack.

The first current collector plate 130 may be made of a conductive material, such as aluminum, and may be electrically coupled to the first electrode non-coating portion 111 protruding from one end of the electrode assembly 110 so as to be electrically connected to the first electrode plate. The first current collector plate 130 may be electrically connected to the first electrode non-coating portion 111 by welding. The first current collector plate 130 may be interposed between a first electrode connection part 131, which extends vertically along one side of the electrode assembly 110, and a first terminal connection part 132, which is interposed between the electrode assembly 110 and the cap assembly 180, and which is coupled to a first terminal 150.

The first electrode connection part 131 extends vertically along one side of the electrode assembly 110, and may be substantially plate-shaped. The first electrode connection part 131 may be coupled through welding during a state of contacting the first electrode non-coating portion 111 of the electrode assembly 110, and may have the same first polarity as the first electrode non-coating portion 111. Hereinafter, for convenience of explanation, a surface of the first electrode connection part 131 facing the electrode assembly 110 will be referred to as an inner surface, and a surface of the first electrode connection part 131 facing the case 170 will be referred to as an outer surface.

The first terminal connection part 132 may include an upper portion approximately having a shape of an “L” rotated 90 degrees. The first terminal connection part 132 may be interposed with an upper portion in an approximately plate shape between the cap assembly 180 and the electrode assembly 110, and a side portion bent downwardly from an outer end of the upper portion to extend and to be coupled to the first electrode connection part 131. The first terminal connection part 132 may be coupled to the first electrode connection part 131 by laser welding to form one first current collector plate 130.

The second current collector plate 140 may be made of a conductive material, such as nickel, and may contact the second electrode non-coating portion 112, which protrudes to the other end of the electrode assembly 110 so as to be electrically connected to the second electrode plate. The second current collector plate 140 may include a second electrode connection part 141 and a second terminal connection part 142. Because a shape of the second current collector plate 140 is the same as or similar to that of the first current collector plate 130, duplicated description will be omitted.

The first terminal 150 may be made of a conductive material, such as aluminum, and may be electrically connected to the first current collector plate 130. The first terminal 150 may include a first terminal pillar 151 and a first terminal plate 152.

The first terminal pillar 151 may protrude through, and may extend upwardly by a corresponding length from, the cap plate 181 of the cap assembly 180, and may be electrically connected to the first current collector plate 130 at the lower portion of the cap plate 181. In some embodiments, the first terminal pillar 151 may protrude and extend to the upper portion of the cap plate 181 by a corresponding length. A lower portion of the first terminal pillar 151 may be inserted into a hole of the first current collector plate 130, and then may be riveted and/or welded.

The first terminal plate 152 has, or defines, a hole, and the upper portion of the first terminal pillar 151 may be coupled to the hole and riveted and/or welded. The first terminal plate 152 may be located on the upper portion of the cap plate 181. In some embodiments, interfaces between the upwardly exposed first terminal pillar 151 and the first terminal plate 152 may be welded to each other. For example, a laser beam may be directed to a boundary area between the upwardly exposed first terminal pillar 151 and the first terminal plate 152, and the boundary area may be melted together, and then may be cooled to be welded. In some embodiments, the first terminal pillar 151 and the first terminal plate 152 may be electrically insulated from the cap plate 181.

The second terminal 160 may be made of a conductive material, such as nickel, and may be electrically connected to the second current collector plate 140. The second terminal 160 may include a second terminal pillar 161 and a second terminal plate 162. Because a shape of the second current terminal 160 is the same as or similar to that of the first terminal 150, duplicated description will be omitted.

The case 170 is formed of a conductive metal, such as aluminum, aluminum alloy, or steel plated with nickel, and has an approximately hexahedral shape provided with an opening through which the electrode assembly 110, the cooling member 120, the first current collector plate 130, and the second current collector plate 140 are inserted and seated. A cap plate 181 may be coupled to the opening of the case 170 to seal the case 170. An inner surface of the case 170 may be basically insulated to reduce or prevent the likelihood of electrical short circuits occurring therein.

The cap assembly 180 may be coupled to the opening of the case 170. The cap assembly 180 may include a cap plate 181, a seal gasket 182, a stopper 183, a safety vent 184, an upper coupling member 185, a lower insulating member 186, and a cooling terminal 187. The cap plate 181 may seal the opening 171 of the case 170. The seal gasket 182 may be made of an insulating material, may be located between the cap plate 181 and the first terminal pillar 151 of the first terminal 150, may be located between the cap plate 181 and the second terminal pillar 161 of the second terminal 160, and may seal a gap between each of the first and second terminal pillars 151 and 161 and the cap plate 181. The seal gasket 182 reduces or prevents the ingress of moisture into the secondary battery 100 or the leakage of the electrolyte from the secondary battery 100.

The stopper 183 may seal an electrolyte injection port of the cap plate 181, and the safety vent 184 may be installed in the vent hole of the cap plate 181, and may be provided with a notch that is openable at a set pressure.

The upper coupling member 185 may be provided between the cap plate 181 and each of the first terminal plate 152 and the second terminal plate 162 at the upper portion of the cap plate 181. In some embodiments, the upper coupling member 185 may closely contact the cap plate 181. In some embodiments, the upper coupling member 185 may closely adhere to the seal gasket 182. The upper coupling member 185 may insulate the first terminal plate 152 and the cap plate 181 from each other, and may insulate the second terminal plate 162 and the cap plate 181 from each other. In some embodiments, the upper coupling member 185 located on the first terminal pillar 151 may electrically connect the first terminal plate 152 to the cap plate 181, and the cap plate 181 may have the same polarity as the first terminal 150. In some embodiments, the case 170 may also have the same polarity as the cap plate 181, and the likelihood of electrical short-circuit with the electrode assembly 110 may be reduced or prevented by internal insulation.

The cooling terminal 187 may be made of a conductive material, and may be electrically connected to the plurality of cooling members 120 through conducting wires 121, respectively. A portion of the cooling terminal 187 may be exposed to an upper side of the cap plate 181. The cooling terminal 187 may pass through the cap plate 181, and a portion of the cooling terminal 187 may be located inside the case 170. A bottom surface of the cooling terminal 187 may contact, and may be electrically connected to, the conducting wire 121. In some embodiments, a sealing member 187a may be further interposed between the cooling terminal 187 and the cap plate 181. The sealing member 187a may electrically insulate the cooling terminal 187 from the cap plate 181. The sealing member 187a may be a seal gasket. In some embodiments, the upper coupling member 185 may seal a gap between the cooling terminal 187 and the cap plate 181.

The cooling terminal 187 may be coupled to a cooling terminal hole of the cap plate 181 downward from the upper side of the cap plate 181, and then may be coupled by riveting. In the present disclosure, the method for coupling the cooling terminal 187 to the cap plate 181 may not be limited. The cooling terminal 187 may be an external input/output terminal, and may transmit current applied from the outside to the cooling member 120.

The secondary battery according to the embodiments may improve the cooling performance because the cooling member electrically connected to the cooling terminal cools the electrode assembly inside the case.

The above are merely embodiments of the secondary battery, and the present disclosure is not limited to the foregoing embodiments, and also it will be understood by those of ordinary skill in the art that various changes in form and details may be made therein without departing from the spirit and scope of the present disclosure as defined by the following claims, with functional equivalents thereof to be included therein.

What is claimed is:

1. A secondary battery comprising:
an electrode assembly comprising a first electrode plate, a separator, and a second electrode plate;
a case accommodating the electrode assembly;
a cap plate sealing the case;
a first terminal electrically connected to the first electrode plate, and exposed to outside the cap plate;
a cooling member inside the case, and contacting the electrode assembly; and
a cooling terminal coupled to the cooling member, and exposed to outside of the cap plate.

2. The secondary battery as claimed in claim 1, wherein the cooling member has a flat plate shape.

3. The secondary battery as claimed in claim 1, wherein the cooling member comprises an inner cooling member between the first electrode plate and the separator, or between the second electrode plate and the separator, inside the electrode assembly.

4. The secondary battery as claimed in claim 3, wherein the cooling member further comprises an outer cooling member that contacts an outer surface of the electrode assembly.

5. The secondary battery as claimed in claim 4, wherein the outer cooling member comprises two outer cooling members respectively contacting and covering long sides of the electrode assembly.

6. The secondary battery as claimed in claim 4, wherein the inner cooling member is between the electrode assemblies at regular intervals.

7. The secondary battery as claimed in claim 4, wherein the cooling member is coupled to the cooling terminal through a conducting wire.

8. The secondary battery as claimed in claim 7, wherein the cooling member and the conducting wire are coated with an insulating material.

9. The secondary battery as claimed in claim 8, wherein the insulating material covers the cooling member and the conducting wire.

10. The secondary battery as claimed in claim 8, wherein the insulating material comprises silica aerogel or polyimide foam.

11. The secondary battery as claimed in claim 1, wherein the cooling member comprises a thermoelectric element or thermoelectric material.

12. The secondary battery as claimed in claim 2, wherein the cooling member has a size that is less than that of the first electrode plate or the second electrode plate.

13. The secondary battery as claimed in claim 1, wherein the electrode assembly comprises a stack-type electrode assembly in which the first electrode plate, the separator, the second electrode plate, and the separator are sequentially stacked.

14. The secondary battery as claimed in claim 1, further comprising a sealing member between the cooling terminal and the cap plate.

15. The secondary battery as claimed in claim 1, wherein the cooling member comprises an outer cooling member contacting an outer surface of the electrode assembly.
